(19) United States
(12) Patent Application Publication
(10) Pub. No.: US 2011/0001695 A1
(43) Pub. Date: Jan. 6, 2011

(54) WEARABLE TERMINAL DEVICE AND METHOD OF CONTROLLING THE WEARABLE TERMINAL DEVICE

(75) Inventors: Katsuyuki Suzuki, Shizuoka (JP); Hitoshi Iizaka, Shizuoka (JP); Nobuyuki Marumo, Shizuoka (JP); Shin Yoshimune, Kanagawa (JP); Morito Natsume, Tokyo (JP); Yasuhiko Mochida, Shizuoka (JP); Nobuo Watanabe, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/824,566

(22) Filed: Jun. 28, 2010

(30) Foreign Application Priority Data
Jul. 6, 2009 (JP) 2009-159866

(51) Int. Cl. G06F 3/01

(52) U.S. Cl. 345/156; 345/7

(57) ABSTRACT

A wearable terminal device includes: a head mounted display including a monitor display unit; a line-of-sight detecting unit for detecting a line-of-sight position of a wearer; a sound collecting unit configured to collect sound uttered by the wearer; a sound recognizing unit configured to recognize a sound command from the wearer on the basis of the collected sound; an operation unit configured to receive operation corresponding to the detected line-of-sight position or operation instructed by the recognized sound command; a setting unit configured to set an operation mode corresponding to work of the wearer out of plural operation modes; and a control unit configured to control, in the set operation mode, display of the monitor display unit corresponding to operation by the wearer.

### CROSS-REFERENCE TO RELATED APPLICATIONS

This application is based upon and claims the benefit of priority from Japanese Patent Application No. 2009-159866 filed Jul. 6, 2009, the entire content of which is incorporated herein by reference.

### FIELD

The present invention relates to a wearable terminal device and a method of controlling the wearable terminal device.

### BACKGROUND

Conventionally, there is a wearable terminal device including a head mounted display (HMD) and attachable to a human body. The wearable terminal device is utilized as one of user interfaces of POS (Point Of Sale) systems in supermarkets, convenience stores, and department stores. As related arts of the wearable terminal device, JP-A-2002-32212 and JP-A-2009-93489 are known.

JP-A-2002-32212 discloses that a line-of-sight direction of a wearer is detected and a video corresponding to a line-of-sight position of the wearer is displayed on a head mounted display. JP-A-2009-93489 discloses a POS terminal worn and used by a casher in a checkout counter in a POS system and configured to display, on a head mounted display, commodity information acquired on the basis of a commodity code included in an image picked up in a direction viewed by the casher. JP-A-2009-93489 discloses that the casher performs checkout processing in the checkout counter.

However, the related arts are limited to the checkout processing in the checkout counter and are not applicable to various kinds of work performed by store clerks in a store. Examples of the work performed by the store clerks include, besides the checkout processing in the checkout counter, stock check for out-of-stock commodities performed in front of a display shelf and stock registration for commodities performed in a backyard such as a commodity warehouse. If it is possible to use the wearable terminal device even for the various kinds of work, labor and time for, for example, detaching the wearable terminal device according to a change of work can be reduced and improvement of workability is expected.

### SUMMARY

The present invention has been devised in view of the above and it is an object of the present invention to provide a wearable terminal device and a method of controlling the wearable terminal device applicable to various kinds of work by a wearer.

In order to attain the object, one aspect of the present invention is a wearable terminal device including: a head mounted display including a monitor display unit; a line-of-sight detecting unit for detecting a line-of-sight position of a wearer; a sound collecting unit configured to collect sound uttered by the wearer; a sound recognizing unit configured to recognize a sound command from the wearer on the basis of the collected sound; an operation unit configured to receive operation corresponding to the detected line-of-sight position or operation instructed by the recognized sound command; a setting unit configured to set an operation mode corresponding to work of the wearer out of plural operation modes; and a control unit configured to control, in the set operation mode, display of the monitor display unit corresponding to operation by the wearer.

Another aspect of the present invention is a method of controlling a wearable terminal device including: a head mounted display including a monitor display unit; a line-of-sight detecting unit for detecting a line-of-sight position of a wearer, a sound collecting unit configured to collect sound uttered by the wearer; a sound recognizing unit configured to recognize a sound command from the wearer on the basis of the collected sound; and an operation unit configured to receive operation corresponding to the detected line-of-sight position or operation instructed by the recognized sound command, the method including: setting an operation mode corresponding to work of the wearer out of plural operation modes; and controlling, in the set operation mode, display of the monitor display unit corresponding to operation by the wearer.

### BRIEF DESCRIPTION OF THE DRAWINGS

FIG. 1 is a diagram of an example of a POS system according to an embodiment;

FIG. 2 is a diagram of an example of a head mounted display according to the embodiment;

FIG. 3 is a diagram of a display example of a monitor display unit;

FIG. 4 is an example of a flowchart for explaining processing by a wearable terminal device according to the embodiment;

FIG. 5 is a diagram of a display example of the monitor display unit; and

FIG. 6 is a diagram of a display example of the monitor display unit.

### DETAILED DESCRIPTION

A wearable terminal device and a method of controlling the wearable terminal device according to an embodiment of the present invention are explained in detail below with reference to the accompanying drawings. In an example explained in this embodiment, the wearable terminal device is applied to a user interface used by a store clerk in a POS system. The wearable terminal device may be one of user interfaces used by workers in a monitoring system in a factory. The wearable terminal device is not specifically limited to the user interface in the POS system.

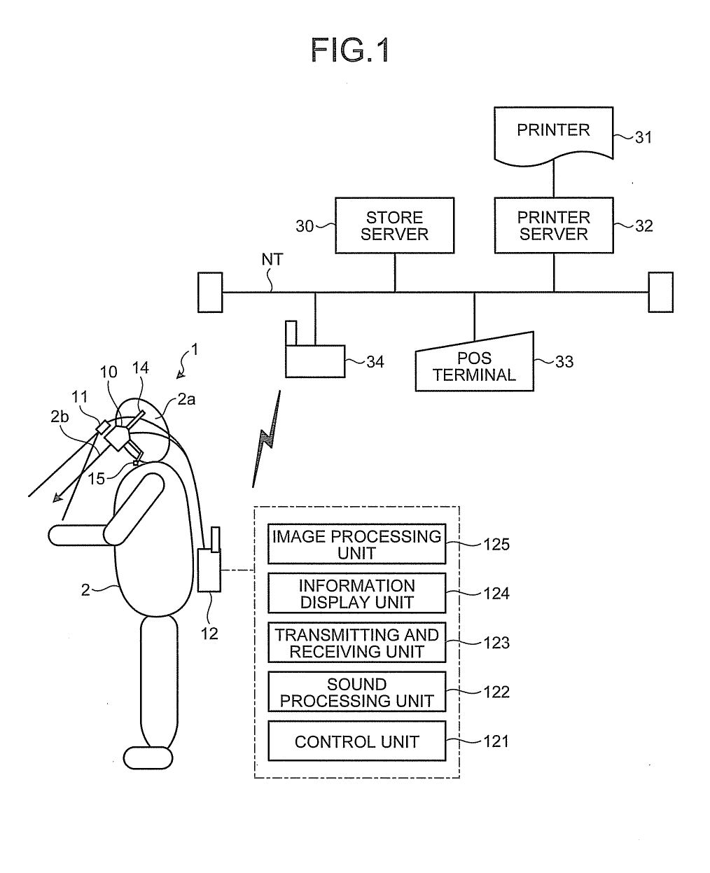

FIG. 1 is a diagram of an example of the POS system according to this embodiment. As shown in FIG. 1, in the POS system, a POS terminal 33, a store server 30 configured to function as a host apparatus of the POS terminal 33, a printer server 32 configured to control a printer 31 for printing various slips, and a transmitting and receiving device 34 for performing transmission and reception of data to and from a wearable terminal device 1 as a user interface worn and used by a wearer 2 are connected to one another via a network NT. The network NT is a LAN (Local Area Network), an intranet, an Ethernet (registered trademark), or the like.

The transmission and reception of data between the transmitting and receiving device 34 and the wearable terminal device 1 may be transmission and reception by a radio wave, light, an infrared ray, ultrasound, or the like. In this embodiment, the transmission and reception of data is performed by using proximity radio communication (e.g., Bluetooth (registered trademark)) having a communication range of about several meters. Therefore, in the POS system, the transmitting and receiving device 34 assigned with a unique ID is set in each of an area near a checkout counter, an area where a display shelf is provided, and an area in a store such as a backyard. In the POS system, it is possible to determine, by identifying the transmitting and receiving device 34 that is communicating with the wearable terminal device 1, in which area the wearable terminal device 1 is present.

The POS terminal 33 includes a drawer, a card reader, a display, and a printer for receipt and journal (all of which are not shown in the figure). The POS terminal 33 is a terminal for performing a business transaction using cash or a credit card and is provided in the checkout counter or the like. Operation by a store clerk during the business truncation by the POS terminal 33 is performed via the wearable terminal device 1 (details of the operation are explained later).

In a store in which such a POS system is installed, barcodes indicating, in a form of codes, various kinds of information concerning various commodities as sales targets are assigned to the commodities. The barcodes do not include commodity data indicating prices of the commodities. Therefore, a commodity master file in which price data is preset to correspond to commodity codes of the various commodities is stored in the store server 30. The POS terminal 33 extracts a commodity code from data of a barcode read via the wearable terminal device 1. Subsequently, the POS terminal 33 inquires of the store server 30 about price data set to correspond to the commodity code. The POS terminal 33 performs checkout for a purchased commodity on the basis of the acquired price data and generates and stores sales data indicating a sales record of the purchased commodity.

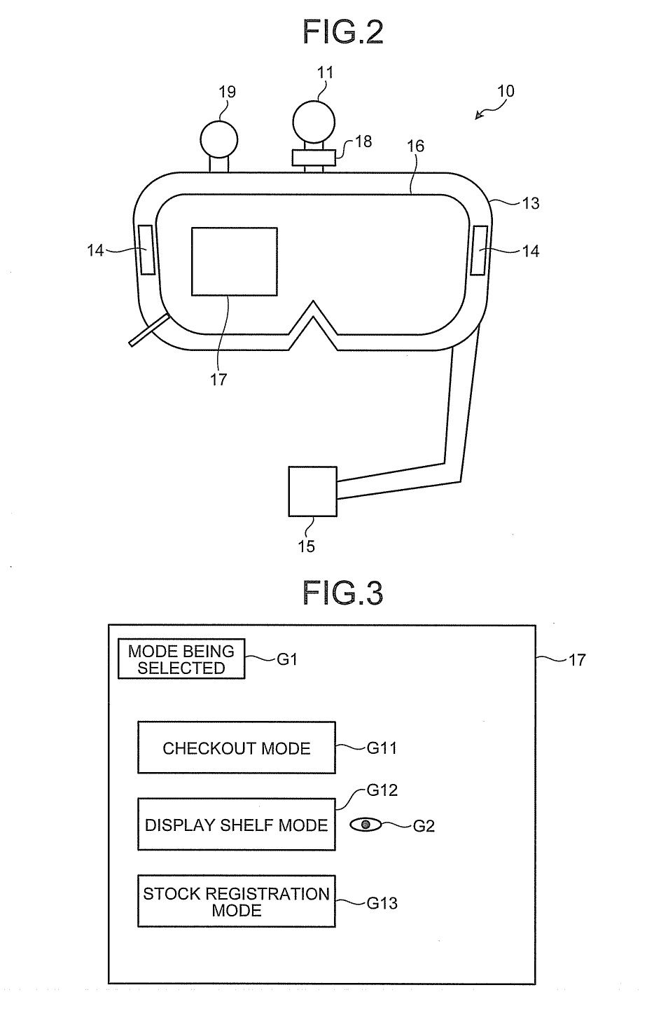

The wearable terminal device 1 includes a head mounted display 10, a digital camera 11 as an image pickup device, an interface box 12, and a microphone 15. The head mounted display 10 includes, as shown in FIG. 2, a frame main body 13 as a holding member formed in a shape of a frame of eyeglasses and mounting arms 14 respectively provided on both the left and right sides of the frame main body 13. The head mounted display 10 is mounted on the head 2a of the wearer 2 by the mounting arms 14 respectively provided on the left and right sides.

The frame main body 13 is formed in a frame shape having size fitted to both the eyes of the wearer 2. The digital camera 11 is provided in the upper center on the outside of the frame of the frame main body 13 via an image-pickup-direction changing mechanism 18. A camera for line-of-sight recognition 19 for picking up an image of the pupil of the wearer 2 and detecting a line of sight 2b is provided on the upper left of the frame main body 13. The microphone 15 for acquiring sound of the wearer 2 and sound around the wearer 2 is provided below the frame main body 13. A tabular light transmissive member 16 formed to be fitted to, for example, a shape of a frame of the frame main body 13 is held in the frame. When the head mounted display 10 is mounted on the head 2a of the wearer 2, the light transmissive member 16 enables the wearer 2 to observe the environment around the wearer 2 with the eyes. For example, the light transmissive member 16 may be colorless and transparent or may have a predetermined color.

A monitor display unit 17 is formed in a part in the light transmissive member 16. The monitor display unit 17 monitors and displays, on a real time basis, image data or the like of a moving image acquired by image pickup by the digital camera 11. The monitor display unit 17 is formed, for example, on the left side in the head mounted display 10. Specifically, the monitor display unit 17 is formed in, for example, a section corresponding to the left eye of the wearer 2 when the head mounted display 10 is mounted on the head 2a of the wearer 2. The monitor display unit 17 may be formed in a section corresponding to the right eye of the wearer 2 or may be formed in each of sections corresponding to both the eyes of the wearer 2. The monitor display unit 17 performs monitor display in a light transmissive state. Therefore, the wearer 2 can observe the environment around the wearer 2 in a state in which image data, various kinds of information, and the like acquired by the image pickup by the digital camera 11 are monitored and displayed on a real time basis.

The digital camera 11 performs image pickup operation and outputs image data of a moving image. The digital camera 11 is attached on the frame main body 13 of the head mounted display 10 with an image pickup range thereof set such that the digital camera 11 is focused in the line of sight 2b direction of the wearer 2 through the light transmissive member 16. The image-pickup-direction changing mechanism 18 supports the digital camera 11 to, for example, allow the digital camera 11 to swing. The image-pickup-direction changing mechanism 18 sets an image pickup direction of the digital camera 11 in an arbitrary direction. As explained above, the image pickup range of the digital camera 11 is set such that the digital camera 11 is focused in the line of sight 2b direction of the wearer 2.

The interface box 12 performs transmission and reception of data to and from the transmitting and receiving device 34 and performs various kinds of processing related to the head mounted display 10. Specifically, the interface box 12 is a box including a control unit 121, a sound processing unit 122, a transmitting and receiving unit 123, an information display unit 124, and an image processing unit 125 and portable by the wearer 2. The control unit 121 is a computer including a CPU (Central Processing Unit), a RAM (Random Access Memory), and a ROM (Read Only Memory) and controls the operation of the wearable terminal device 1. In the ROM, computer programs, various kinds of setting information referred to in executing the computer programs, and the like are stored in advance. The CPU expands the computer programs stored in the ROM in a work area of the RAM and sequentially executes the computer programs to centrally control the operation of the wearable terminal device 1. For example, if an operation mode is a checkout mode, the control unit 121 outputs image data acquired by image pickup by the digital camera 11 to the information display unit 124 and causes the monitor display unit 17 of the head mounted display 10 to display the image data on a real time basis. Further, the control unit 121 outputs the image data acquired by the image pickup by the digital camera 11 to the image processing unit 125 and causes the image processing unit 125 to subject the image data to image processing. In this way, the control unit 121 causes the image processing unit 125 to decode a barcode attached to a commodity, an image of which is picked up, to acquire a commodity code. Subsequently, the control unit 121 notifies the store server 30 of the acquired commodity code via the transmitting and receiving unit 123 and the transmitting and receiving device 34. The control unit 121 outputs commodity information (a commodity code, a commodity name, a unit price, etc.) returned from the store server 30 in response to the notification to the information display unit 124 and causes the monitor display unit 17 to display the commodity information. The control unit 121 may execute the computer programs stored in the ROM in advance to realize the units such as the image processing unit 125, the information display unit 124, the transmitting and receiving unit 123, and the sound processing unit 122 in the interface box 12.

The sound processing unit 122 performs processing for identification of sound input through the microphone 15 and recording of the sound. Specifically, the sound processing unit 122 collates sound data included in dictionary data set in advance and sound data from the microphone 15 and recognizes a predetermined sound command. Subsequently, the sound processing unit 122 notifies the control unit 121 of the recognized sound command. The control unit 121 performs processing corresponding to the notified sound command. Consequently, the wearable terminal device 1 can perform operation instructed by the sound command. The sound processing unit 122 converts, under the control by the control unit 121, the sound data from the microphone 15 into sound data of a predetermined format and records the sound data after the conversion in, for example, the RAM of the control unit 121 and the store server 30 connected to the interface box 12 via the transmitting and receiving unit 123 and the transmitting and receiving device 34.

The information display unit 124 displays image data input from the control unit 121 or the like on the monitor display unit 17 of the head mounted display 10. Specifically, the information display unit 124 displays the image data acquired by the image pickup by the digital camera 11 on the monitor display unit 17. When the information display unit 124 receives information such as a commodity code, a commodity name, a unit price, and various icon images, the information display unit 124 combines the received information with the input image data and displays the information on the monitor display unit 17 of the head mounted display 10. When a display position of the received information is designated by coordinates or the like, the information display unit 124 combines the information with the input image data such that the information is displayed in the designated display position.

The image processing unit 125 performs image processing for the image data acquired by the image pickup by the digital camera 11. The image processing unit 125 analyzes image data picked up by the camera for line-of-sight recognition 19 and detects the line of sight 2b of the wearer 2. Specifically, the image processing unit 125 detects the pupil of the wearer 2 from the image data picked up by the camera for line-of-sight recognition 19 and detects the line of sight 2b according to the position of the detected pupil. The image processing unit 125 chapters one frame from the image data acquired by the image pickup by the digital camera 11. Subsequently, the image processing unit 125 performs image processing for, for example, identifying a barcode in the chaptered image and binarizing identified image data to acquire a commodity code. The image processing unit 125 may display image data of the one frame chaptered from the image data acquired by the image pickup by the digital camera 11 on the monitor display unit 17 of the head mounted display 10 and, for example, add a frame line or the like surrounding the identified barcode to the chaptered image at a point when the chaptered image is acquired or a point when the binarized data is acquired. The frame line may be colored in red, yellow, or the like in a form of a rectangle or the like. The image processing unit 125 may identify, from the chaptered image, a barcode included in an area corresponding to the line of sight 2b detected on the basis of an image of the camera for line-of-sight recognition 19. In this case, it is possible to perform input of a commodity code by the line of sight 2b of the wearer 2.

Operation input in the wearable terminal device 1 may be performed under the control by the control unit 121 according to the line of sight 2b detected by the image processing unit 125 on the basis of the image of the camera for line-of-sight recognition 19. Specifically, the image processing unit 125 detects the line of sight 2b of the wearer 2 looking at an icon image for operation input displayed on the monitor display unit 17 by the information display unit 124. The wearable terminal device 1 performs the operation input according to the detection of the line of sight 2b. FIG. 3 is a diagram of a display example of the monitor display unit 17. Specifically, a display example in setting an operation mode according to the line of sight 2b is shown. As shown in FIG. 3, a display area G1 is an area where an operation state of the wearable terminal device 1 such as a present operation mode is displayed. A line-of-sight marker G2 is a marker indicating the line of sight 2b detected by the image processing unit 125 on the basis of the image of the camera for line-of-sight recognition 19. Icon images G11 to G13 are icons for setting operation modes of the wearable terminal device 1. When display coordinates of any one of the icon images G11 to G13 coincide with coordinates of the line-of-sight marker G2, the control unit 121 sets an operation mode of the icon image having the coinciding coordinates. In this way, the wearable terminal device 1 performs the operation input such as the setting of an operation mode according to the line of sight 2b of the wearer 2.

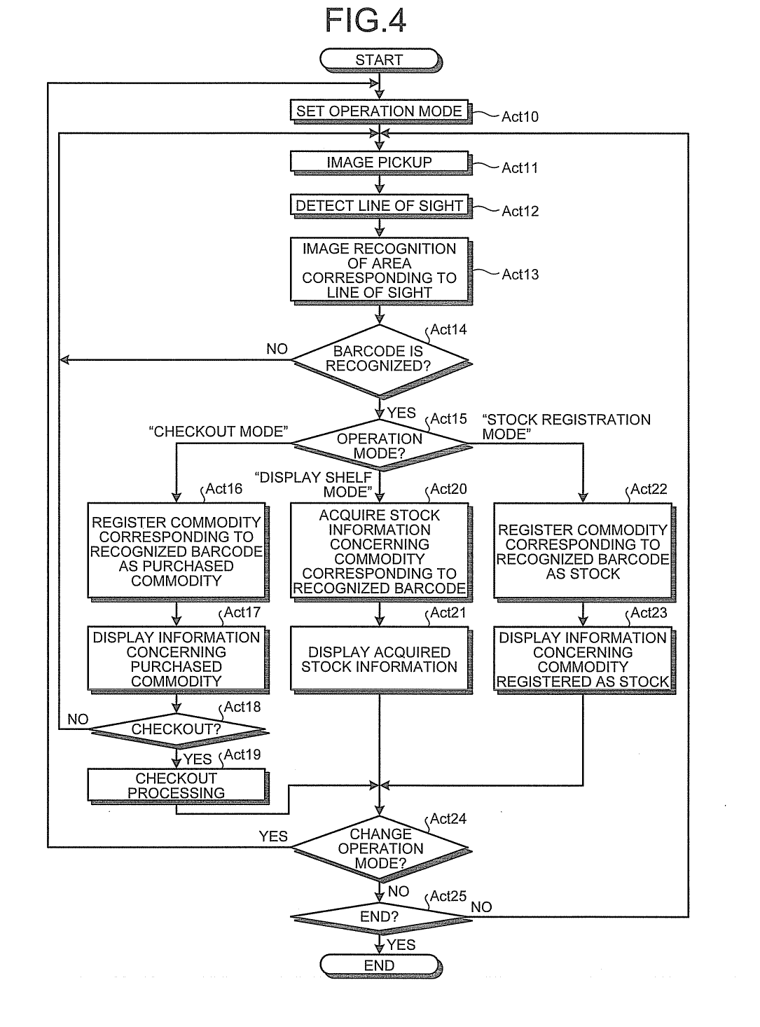

A procedure of processing performed by the wearable terminal device 1 under the control by the control unit 121 is explained with reference to FIG. 4. FIG. 4 is a flowchart for explaining processing by the wearable terminal device 1 according to this embodiment.

As shown in FIG. 4, when the processing is started, the control unit 121 sets an operation mode of the wearable terminal device 1 (Act 10). As the operation mode of the wearable terminal device 1 to be set, there are a “checkout mode”, a “display shelf mode” (check mode), and a “stock registration mode” (registration mode). The “checkout mode” is an operation mode for the wearer 2 wearing the wearable terminal device 1 to perform checkout processing such as registration and checkout for purchased commodities in front of the POS terminal 33. The “display shelf mode” is an operation mode for the wearer 2 wearing the wearable terminal device 1 to perform stock check or the like of out-of-stock commodities in a display shelf. The “stock registration mode” is an operation mode for performing registration or the like of stock commodities in a backyard or the like. The setting of an operation mode in Act 10 is performed according to the line of sight 2b of the wearer 2 as explained with reference to FIG. 3.

The setting of an operation mode in Act 10 may be performed through operation input by an operation button (not specifically shown in the figure) provided in the wearable terminal device 1 or may be performed according to a sound command of the wearer 2 identified by the sound processing unit 122. Specifically, the control unit 121 identifies which of the “checkout mode”, the “display shelf mode”, and the “stock registration mode” is uttered by the wearer 2 and sets the identified operation mode. In this way, it is unnecessary to perform complicated input operation in the setting of an operation mode corresponding to the sound command of the wearer 2. The control unit 121 may perform the setting of an operation mode according to in which area in the store the wearable terminal device 1 is present. Specifically, as explained above, the control unit 121 determines, on the basis of transmission and reception of data between the transmitting and receiving device 34 and the wearable terminal device 1, in which area in the store the wearable terminal device 1 is present. Subsequently, if a result of the determination indicates that the area is an area near the checkout counter, the control unit 121 sets the “checkout mode”. If the area is an area where a display shelf is provided, the control unit 121 sets the “display shelf mode”. If the area is the backyard, the control unit 121 sets the “stock registration mode”. The control unit 121 may detect, according to a recognition result obtained by subjecting an image picked up by the digital camera 11 to image recognition with the image processing unit 125, in which area in the store the wearable terminal device 1 is present. Specifically, the control unit 121 performs the image recognition on the basis of images of the checkout counter, the display shelf, the backyard, and the like picked up in advance. For example, if the checkout counter is recognized from the image picked up by the digital camera 11, the control unit 121 sets the “checkout mode”. If the display shelf is recognized, the control unit 121 sets the “display shelf mode”. If the backyard is recognized, the control unit 121 sets the “stock registration mode”. In this way, the operation mode corresponding to the position of the wearable terminal device 1 is set. Therefore, the wearer 2 wearing the wearable terminal device 1 does not need to take the trouble to set an operation mode after moving to a predetermined work position. This makes it possible to improve workability.

Subsequently, the control unit 121 performs image pickup by the digital camera 11 and the camera for line-of-sight recognition 19 (Act 11). The control unit 121 causes the image processing unit 125 to detect the line of sight 2b according to image data picked up by the camera for line-of-sight recognition 19 (Act 12). The control unit 121 causes the image processing unit 125 to perform image recognition of an area corresponding to the line of sight 2b detected in Act 12 in an image picked up by the digital camera 11 (Act 13). The control unit 121 determines whether a barcode is recognized by the image recognition in Act 13 (Act 14). The image recognition in Act 13 includes, for example, recognition of a barcode and presence or absence of overlap of the line of sight 2b and an icon image. The area corresponding to the line of sight 2b in Act 13 may be, for example, an area set in advance around the line of sight 2b. The recognition of a barcode by the image recognition is image processing performed by the image processing unit 125 for, for example, identifying an image of a barcode in the corresponding area and binarizing the identified image to decode the image to a commodity code.

If a barcode is not recognized (No in Act 14), the control unit 121 returns the processing to Act 11. Therefore, in the wearable terminal device 1, the image pickup by the digital camera 11 and the camera for line-of-sight recognition 19 and the image recognition of the area corresponding to the line of sight 2b are continuously performed. If a barcode is recognized (Yes in Act 14), the control unit 121 determines which of the “checkout mode”, the “display shelf mode”, and the “stock registration mode” the operation mode set in Act 10 is (Act 15).

If the operation mode is the “checkout mode”, the control unit 121 notifies the store server 30 of a commodity code, which is obtained by decoding the recognized barcode, as registration information concerning a purchased commodity via the transmitting and receiving unit 123 and the transmitting and receiving device 34 and registers the purchased commodity (Act 16). Subsequently, the control unit 121 causes the monitor display unit 17 to display commodity information (a commodity code, a commodity name, a unit price, etc.) of the purchased commodity returned from the store server 30 in response to the registration of the purchased commodity in Act 16 (Act 17). If the operation mode is the “checkout mode”, the processing in Acts 11 to 17 is looped until it is determined in determination of checkout processing explained later (Act 18) that the checkout processing is performed. Therefore, in the wearable terminal device 1, the registration of a purchased commodity by the line of sight 2b of the wearer 2 and the display of commodity information concerning the purchased commodity on the monitor display unit 17 are continued.

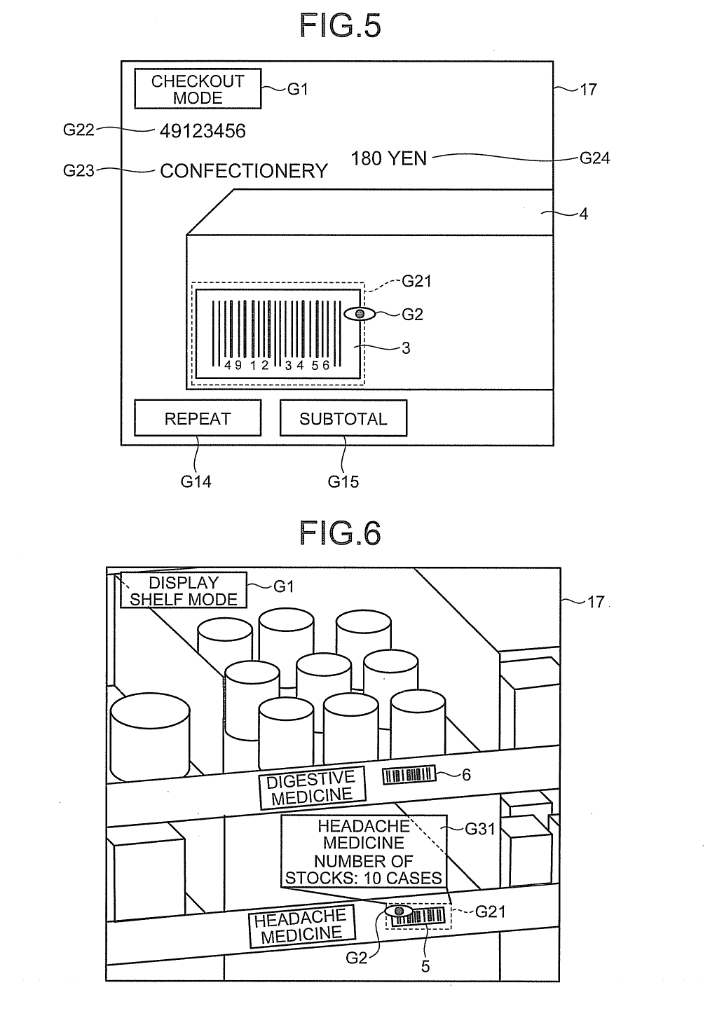

FIG. 5 is a diagram of a display example of the monitor display unit 17. Specifically, a display example performed when the operation mode is the “checkout mode” is shown. As shown in FIG. 5, in Act 17, the “checkout mode” as the present operation mode is displayed in the display area G1. A commodity 4 is, for example, a commodity carried to the checkout counter by a customer as a commodity that the customer purchases and picked up by the wearer 2 of the wearable terminal device 1 in performing checkout. A barcode 3 corresponding to the commodity 4 is attached to the commodity 4. The line of sight 2b of the wearer 2 shifts to the barcode 3 (the line-of-sight marker G2 overlaps the barcode 3), whereby the barcode 3 is identified. At this point, an image recognition frame G21 is added to the identified barcode 3. A commodity code of the identified barcode 3 is notified to the store server 30, whereby registration of the purchased commodity is performed. Commodity information returned from the store server 30 in response to the registration of the purchased commodity is displayed on the monitor display unit 17 as a commodity code G22, a commodity name G23, and a unit price G24.

Icon images G14 and G15 are icons for receiving, with the line-of-sight marker G2, an operation instruction in the registration of the purchased commodity. The icon images G14 and G15 are screen-displayed when the operation mode is the “checkout mode”. For example, when the line-of-sight marker G2 overlaps the icon image G14 and an instruction for “repeat” is input, the barcode 3 is not read and registration of a commodity same as a purchased commodity registered immediately before the commodity registration is performed again. When the line-of-sight marker G2 overlaps the icon image G15 and an instruction for “subtotal” is input, checkout processing for calculating a total amount of sequentially-registered purchased commodities is performed.

Subsequently, the control unit 121 determines presence or absence of checkout processing corresponding to the operation of the icon image G15 by the line of sight 2b of the wearer 2 (Act 18). If the checkout processing is not performed (No in Act 18), the control unit 121 returns the processing to Act 11 to continue registration of a purchased commodity. If the checkout processing is performed by the operation of the icon image G15 by the line of sight 2b of the wearer 2 (Yes in Act 18), the control unit 121 notifies the store server 30 to perform the checkout processing and causes the POS terminal 33 to perform the checkout processing (Act 19). Specifically, the control unit 121 causes the store server 30 to calculate a total amount of sequentially-registered purchased commodities and causes the POS terminal 33 to perform checkout for the calculated total amount by cash or a credit card.

If the operation mode is the “display shelf mode” in Act 15, the control unit 121 notifies the store server 30 of the commodity code, which is obtained by decoding the recognized barcode, as stock check information via the transmitting and receiving unit 123 and the transmitting and receiving device 34 and acquires stock information such as the number of stocks of a commodity indicated by the commodity code from the store server 30 (Act 20). Subsequently, the control unit 121 causes the monitor display unit 17 to display the stock information acquired in Act 20 (Act 21). In the display shelf mode, the control unit 121 acquires, on the basis of an image picked up by the digital camera 11, an image of a shelf on which an out-of-stock occurs in the display shelf according to image recognition of an area where the line of sight 2b of the wearer 2 is detected. Subsequently, the control unit 121 compares the acquired image and an image of the display shelf without commodities placed thereon stored in the ROM or the like in advance to thereby specify the position of the shelf on which the out-of-stock occurs. The control unit 121 specifies a commodity that should be placed in the specified position of the shelf. The control unit 121 acquires a mark indicating out-of-stock from the image of the shelf on which the out-of-stock occurs and compares the acquired mark and a mark image for each of positions of the display shelf stored in the ROM or the like in advance. The control unit 121 may specify, according to the comparison, the position of the shelf on which the out-of-stock occurs and specify a commodity that should be placed in the specified shelf.

FIG. 6 is a diagram of a display example of the monitor display unit 17. Specifically, a display example performed when the operation mode is the “display shelf mode” is shown in FIG. 6. As shown in FIG. 6, in Act 21, the “display shelf mode” as the present operation mode is displayed in the display area G1. Barcodes 5 and 6 include commodity codes of commodities out-of-stock in the display shelf, for example, in order to notify the store server 30 of the out-of-stock commodities. In an example shown in the figure, in the display shelf, the barcode 5 including a commodity code of a headache medicine is provided to correspond to a place where commodities of the headache medicine are displayed. In the display shelf, the barcode 6 including a commodity code of a digestive medicine is provided to correspond to a place where commodities of the digestive medicine are displayed. For example, the line-of-sight 2b of the wearer 2 shifts to the barcode 5 (the line-of-sight marker G2 overlaps the barcode 5), whereby the wearable terminal device 1 identifies the barcode 5. At this point, the image recognition frame G21 is added to the identified barcode 5. The wearable terminal device 1 notifies the store server 30 of a commodity code of the identified barcode 5 to acquire stock information concerning the headache medicine from the store server 30. The acquired stock information is displayed in an information window G31 of the monitor display unit 17.

If the operation mode is the “stock registration mode” in Act 15, the control unit 121 notifies the store server 30 of the commodity code, which is obtained by decoding the recognized barcode, as stock registration information concerning a commodity via the transmitting and receiving unit 123 and the transmitting and receiving device 34 and performs stock registration in a commodity master table stored in the store server 30 (Act 22). Subsequently, the control unit 121 causes the monitor display unit 17 to display commodity information (a commodity code, a commodity name, a unit price, etc.) of the registered commodity returned from the store server 30 in response to the stock registration in Act 22 (Act 23). Display by the monitor display unit 17 performed when the operation mode is the “stock registration mode” is substantially the same as the display example of the “checkout mode” shown in FIG. 5. On the monitor display unit 17, the “stock registration mode” is displayed in the display area G1. Display by the monitor display unit 17 performed when the operation mode is the “stock registration mode” may be different from the display in the case of the “checkout mode” only in that the icon images G14 and G15 are not displayed. Processing in the “stock registration mode” may be, besides the stock registration, quantity check for notifying the store server 30 of the commodity code obtained by decoding the recognized barcode, acquiring the number of stocks of a commodity corresponding to the commodity code from the commodity master table stored in the store server 30, and displaying the number of stocks on the monitor display unit 17.

Subsequently, the control unit 121 determines whether a change of the operation mode is instructed by operation input by the line of sight 2b of the wearer 2, a sound command, or the like (Act 24). If the change of the operation mode is instructed (Yes in Act 24), the control unit 121 returns the processing to Act 10. If the change of the operation mode is not instructed (No in Act 24), the control unit 121 determines whether the end of the processing is instructed by operation input by the line of sight 2b of the wearer 2, a sound command, or the like (Act 25). If the end of the processing is not instructed and the processing is continued (No in Act 25), the control unit 121 returns the processing to Act 11. When the end of the processing is instructed (Yes in Act 25), the control unit 121 ends the processing.

As explained above, the wearable terminal device 1 changes, according to the set operation mode, the processing performed by the operation input by the line of sight 2b of the wearer 2. Therefore, the wearable terminal device 1 is applicable to various kinds of work. For example, if the operation mode is the “checkout mode”, registration of a purchased, commodity by the barcode 3 identified according to the line of sight 2b of the wearer 2 is performed. At this point, the icon images G14 and G15 corresponding to the “checkout mode” are displayed on the monitor display unit 17. Therefore, the wearable terminal device 1 can perform operation input necessary in checkout according to the line of sight 2b of the wearer 2. If the operation mode is the “display shelf mode”, stock information acquired from the store server 30 by the barcode 5 identified according to the line of sight 2b of the wearer 2 is displayed on the monitor display unit 17. If the operation mode is the “stock registration mode”, stock registration by the barcode identified according to the line of sight 2b of the wearer 2 is performed. At this point, commodity information concerning a registered commodity corresponding to the “stock registration mode” is displayed on the monitor display unit 17. When the quantity check is performed, the number of stocks of a commodity corresponding to the commodity code obtained by decoding the barcode according to the line of sight 2b of the wearer 2 is displayed on the monitor display unit 17.

In the example explained in this embodiment, the operation mode of the wearable terminal device 1 is displayed as characters in the display area G1 of the monitor display unit 17. However, notification of the operation mode to the wearer 2 is not limited to this embodiment. For example, the notification may be sound notification by a speaker (not shown) provided in the interface box 12 or the like or notification by a display device (not shown) other than the monitor display unit 17 such as an LED (Light Emitting Diode). A display form on the monitor display unit 17 is not limited to character display in the display area G1 and may be a display form without the use of characters such as switching to a background color corresponding to an operation mode. In particular, when monitor display is performed in the light transmissive state in front of the wearer 2, the fatigue of the wearer 2 is reduced by limiting character information displayed on the monitor display unit 17 to necessary minimum. Therefore, the display form without the use of characters is preferable. Further, the line of sight 2b is stabilized when the line of sight 2b of the wearer 2 is detected to perform operation input. Therefore, concerning an operation mode always displayed on the monitor display unit 17, it is preferable to display a background color corresponding to a present operation mode.

In the example explained in this embodiment, on the basis of an image picked up by the digital camera 11, a barcode is recognized according to the image recognition of an area where the line of sight 2b of the wearer 2 is detected. However, the image recognition is not limited to the recognition of a barcode. For example, on the basis of the image picked up by the digital camera 11, a commodity shape is recognized according to the image recognition of an area where the line of sight 2b of the wearer 2 is detected. The commodity shape is compared with a commodity shape stored in the ROM or the like in advance. According to this comparison, the wearable terminal device 1 may specify a commodity subjected to checkout or stock registration.

In the example explained in this embodiment, the sound processing unit 122 configured to perform sound recognition and the like and the image processing unit 125 configured to perform image recognition and the like are included in the interface box 12. However, the interface box 12 does not have to include the sound processing unit 122 and the image processing unit 125. The processing performed by the sound processing unit 122 and the image processing unit 125 may be performed in the store server 30 or the like to which image data and sound data are transmitted by the transmitting and receiving unit 123. When the processing by the sound processing unit 122 and the image processing unit 125 is performed in the store server 30, the wearable terminal device 1 receives a processing result of the store server 30 in the transmitting and receiving unit 123.

The computer programs executed by the control unit 121 according to this embodiment may be provided while being incorporated in the ROM or the like in advance. The computer programs may be provided while being recorded in a computer-readable recording medium such as a CD-ROM, a flexible disk (FD), a CD-R, or a DVD as a file of an installable form or an executable form.

The computer programs may be provided by being stored on a computer connected to a network such as the Internet and downloaded through the network. The computer programs may be provided or distributed through the network such as the Internet.

The present invention is not limited to the embodiment per se. At an implementation stage, the elements of the embodiment can be modified and embodied without departing from the spirit of the invention. Various inventions can be formed by appropriate combinations of the plural elements disclosed in the embodiment. For example, several elements may be deleted from all the elements explained in the embodiment. Further, elements explained in the different embodiments may be combined as appropriate.

Further effects and modifications of the present invention can be easily derived by those skilled in the art. Therefore, the invention in its broader aspects is not limited by the specific details and the representative embodiments represented and described above. Accordingly, various modifications can be made without departing from the spirit or the scope of the general inventive concept as defined by the appended claims and their equivalents.

What is claimed is:

1. A wearable terminal device comprising:
a head mounted display including a monitor display unit;
a line-of-sight detecting unit for detecting a line-of-sight position of a wearer;
a sound collecting unit configured to collect sound uttered by the wearer;
a sound recognizing unit configured to recognize a sound command from the wearer on the basis of the collected sound;
an operation unit configured to receive operation corresponding to the detected line-of-sight position or operation instructed by the recognized sound command;
a setting unit configured to set an operation mode corresponding to work of the wearer out of plural operation modes; and
a control unit configured to control, in the set operation mode, display of the monitor display unit corresponding to operation by the wearer.

2. The device according to claim 1, further comprising:
an image pickup unit; and
an image recognizing unit configured to perform image recognition for an area corresponding to the detected line-of-sight position from an image picked up by the image pickup unit, wherein
the control unit controls, in the set operation mode, processing corresponding to a result of the recognition by the image recognizing unit.

3. The device according to claim 2, wherein
the image recognizing unit recognizes a predetermined code or a predetermined image included in the area, and
the control unit controls, in the set operation mode, processing performed by using the predetermined code or the predetermined image.

4. The device according to claim 1, further comprising a position detecting unit configured to detect a position of the device, wherein
the setting unit sets the operation mode corresponding to the detected position of the device.

5. The device according to claim 1, wherein the setting unit sets the operation mode according to operation by the wearer through the operation unit.

6. The device according to claim 1, wherein the monitor display unit performs display corresponding to the set operation mode.

7. The device according to claim 1, wherein the monitor display unit performs display corresponding to the operation mode by switching a background color.

8. The device according to claim 1, wherein the monitor display unit performs display in a light transmissive state.

9. The device according to claim 1, wherein the plural operation modes include a checkout mode for performing checkout for a commodity, a check mode for performing check of a commodity, and a registration mode for performing registration of a commodity.

10. A method of controlling a wearable terminal device including: a head mounted display including a monitor display unit; a line-of-sight detecting unit for detecting a line-of-sight position of a wearer, a sound collecting unit configured to collect sound uttered by the wearer; a sound recognizing unit configured to recognize a sound command from the wearer on the basis of the collected sound; and an operation unit configured to receive operation corresponding to the detected line-of-sight position or operation instructed by the recognized sound command,
the method comprising:
setting an operation mode corresponding to work of the wearer out of plural operation modes; and
controlling, in the set operation mode, display of the monitor display unit corresponding to operation by the wearer.
